(19) United States
(12) Patent Application Publication
(10) Pub. No.: US 2011/0289349 A1
(43) Pub. Date: Nov. 24, 2011

(54) System and Method for Monitoring and Repairing Memory

(75) Inventors: Matthias J. Loeser, Pleasanton, CA (US); Daniel V. Singletary, Cupertino, CA (US); Sanjeev A. Joshi, San Jose, CA (US); Shadab Nazar, Sunnyvale, CA (US)

(73) Assignee: Cisco Technology, Inc., San Jose, CA (US)

(21) Appl. No.: 12/785,812

(22) Filed: May 24, 2010

(51) Int. Cl. G06F 11/26; G06F 11/20; G06F 11/10; G06F 11/16; G06F 11/00

(52) U.S. Cl. 714/6.24; 714/42; 714/E11.084; 714/E11.159; 714/6.3

(57) ABSTRACT

Monitoring and repairing memory includes selecting a first memory bank comprising a plurality of memory cells to analyze. The plurality of memory cells are copied from the first memory bank to a second memory bank, wherein a request to access the first memory bank is redirected to the second memory bank. A determination is made whether the first memory bank comprises an error of the memory cell.

### TECHNICAL FIELD OF THE INVENTION

This invention relates generally to computers, and, more specifically, to monitoring and repairing memory.

### BACKGROUND OF THE INVENTION

Entities use memory solutions to store information for later retrieval and use. Memory solutions are prone to errors, which may effect the functionality of the memory. To fix these errors, current memory solutions are taken offline and are unavailable while being repaired.

### SUMMARY OF THE DISCLOSURE

In accordance with the teachings of the present disclosure, disadvantages and problems associated with previous memory solutions can be reduced or eliminated by providing a system and method for monitoring and repairing memory.

According to one embodiment of the present disclosure, monitoring and repairing memory includes selecting a first memory bank comprising a plurality of memory cells to analyze. The plurality of memory cells are copied from the first memory bank to a second memory bank, wherein a request to access the first memory bank is redirected to the second memory bank. A determination is made whether the first memory bank comprises an error of the memory cell.

Certain embodiments of the present disclosure may provide one or more technical advantages. A technical advantage of one embodiment includes monitoring and repairing memory during operation of the memory. Another technical advantage may include monitoring and repairing memory errors in a non-disruptive manner, which allows a user to access memory while the memory is monitored and a part of the memory is being repaired. A benefit may include the ability to perform at-speed memory analysis, and monitoring and repairing memory during operation of the memory with no corresponding performance degradation. In addition, monitoring and repairing memory during operation of the memory may extend the serviceable life of the memory. Another technical advantage may include increasing the reliability of the device that includes a system for monitoring and repairing memory. Still another benefit may include achieving a higher error coverage and/or identification rate over previous memory solutions. The system may include the ability to track the degradation of a memory bank and/or take a memory bank out of service that is too degraded to continue operating. Accordingly, a system that monitors and repairs memory during the operation of the memory may continue operating even if a memory bank has been taken out of service, and monitoring and repairing memory may be performed continuously during operation of the memory.

Certain embodiments of the present disclosure may include none, some, or all of the above technical advantages. One or more other technical advantages may be readily apparent to one skilled in the art in view of the figures, descriptions, and claims of the present disclosure.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example embodiment of a system for monitoring and repairing memory;

FIG. 2 is a block diagram illustrating an example embodiment of a device for monitoring and repairing memory;

FIG. 3A is a flowchart illustrating an example method for monitoring and repairing memory;

FIG. 3B is a flowchart illustrating an example method for repairing memory; and

FIG. 4 is a flowchart illustrating an example method for accessing a repairable memory.

### DETAILED DESCRIPTION OF THE INVENTION

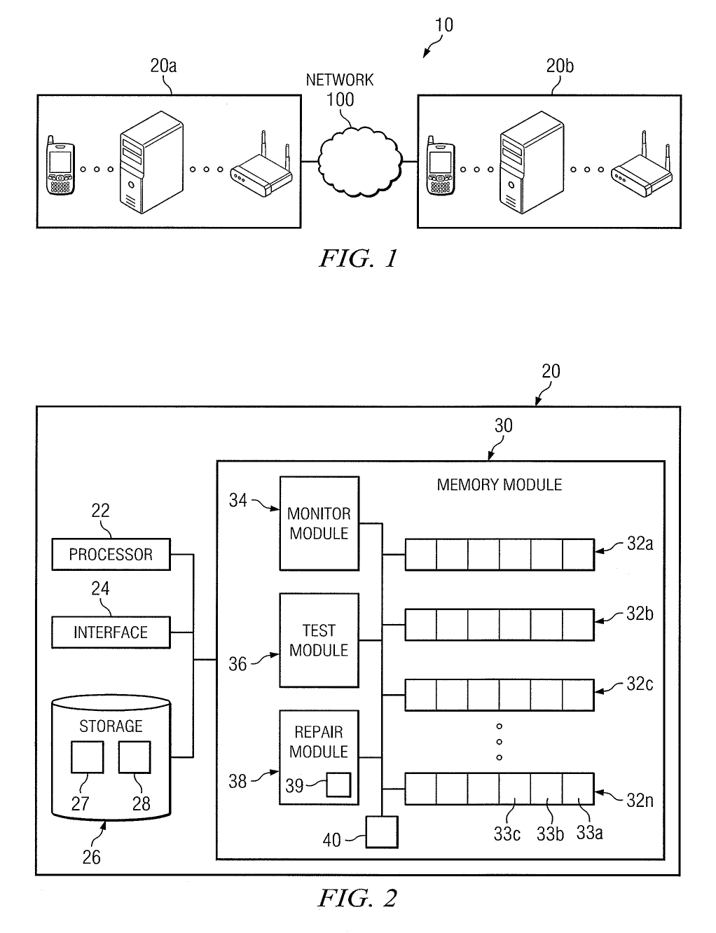

Embodiments of the present invention and its advantages are best understood by referring to FIGS. 1 through 4, wherein like numerals refer to like and corresponding parts of the various drawings.

FIG. 1 is a block diagram illustrating an example embodiment of a system 10 for monitoring and repairing memory online. System 10 comprises devices 20a and 20b that communicate over network 100, and devices 20 may monitor and repair memory during operation of the memory. For purposes of the present disclosure, memory that is being operated and/or is online refers to memory that is currently in operation, is currently available to fulfill requests to access data, and/or is actively fulfilling requests to access data.

Over time, entities have increasingly utilized information technology solutions to improve the capacity and efficiency of processes. Accordingly, the need for reliable and serviceable information technology components has also increased. Unreliable components having failures that result in downtime are not acceptable to entities that rely on information technology services to support critical processes. For example, failed memory in a server or network component typically results in downtime of the associated information technology solution, which may cause monetary losses. Similarly, monitoring and repairing memory typically requires taking the memory offline, thus rendering the device hosting the memory inoperable for the duration of the monitor or repair operation. Accordingly, the teachings of this disclosure recognize the desirability of a solution that monitors and repairs memory online. An advantage of monitoring and repairing memory during operation of the memory is increased reliability and/or decreased system downtime.

Devices 20a and 20b represent any component suitable for communication. For example, devices 20 include any collection of hardware, software, and/or controlling logic operable to communicate with other devices over communication network 100 and to monitor and repair memory online as described in greater detail with respect to FIG. 2. For example, device 20 may represent any computing device such as a server, network component, mobile device, storage device, or any other appropriate device that utilizes memory in its operations.

Network 100 represents any suitable network operable to facilitate communication between the components coupled to system 10 such as device 20a and device 20b. In various embodiments, network 100 may include all or a portion of one or more networks, such as a telecommunication network, a satellite network, a cable network, a local area network (LAN), a wireline or wireless network, a wide area network (WAN), the Internet, and/or any other appropriate networks.

In operation, devices 20 interact with network 100 to communicate within system 10. For example, device 20 may route data packets and/or other information over network 100 to provide network services. As another example, device 20 may provide business processes delivered over the Internet in the form of information technology solutions. According to the illustrated embodiment, devices 20 are capable of monitoring and repairing memory online. It should be understood, however, that while devices 20 are illustrated as communicating over network 100, the scope of the present disclosure encompasses any appropriate device capable of monitoring and repairing memory online, including standalone and/or non-network devices.

FIG. 2 is a block diagram illustrating an example embodiment of a device 20 comprising a system for monitoring and repairing memory. Device 20 includes processor 22, interface 24, storage 26, code 27, and files 28 to facilitate monitoring and repairing memory module 30. Generally, processor 22 controls the operation of device 20 by interacting with interface 24, storage 26 and memory module 30. Memory module 30 includes multiple memory banks 32, monitor module 34, test module 36, repair module 38, memory table 39, and alternate memory 40 to monitor and repair itself during its operations. Monitor module 34 monitors memory banks 32, test module 36 analyzes memory banks 32 to detect errors, and repair module 38 repairs detected errors.

Processor 22 represents any suitable collection of hardware, software, and/or controlling logic operable to control the operation and administration of elements within device 20. For example, processor 22 may operate to process information and/or commands received from interface 24, storage 26, and memory module 30. For example, processor 22 may be a microcontroller, processor, programmable logic device, and/or any other suitable processing device. As another example, processor 22 may be operable to receive information on interface 24 and determine whether the information should be stored in storage 26 and/or memory module 30. Processor 22 may be operable to request access to data stored in memory cells 33 within memory banks 32 of memory module 30. Requests for access to data may include requests to read stored data and/or write new data. Processor 22 may be capable of performing any number of operations on data read from memory cells 33. In various embodiments, processor 22 represents multiple parallel and/or multi-core processors.

Interface 24 represents any suitable collection of hardware, software, and/or controlling logic capable of communicating information to and receiving information from elements within system 10 and/or device 20. For example, interface 24 may represent a network interface card (NIC), Ethernet card, port application-specific integrated circuit (port ASIC), or other appropriate interface. In some embodiments, interface 24 may include an interface capable of transmitting information and/or instructions between processor 22 and memory 30.

Storage 26 represents any one or a combination of volatile or non-volatile local or remote devices suitable for storing information. For example, storage 26 may include random access memory (RAM), read only memory (ROM), magnetic storage devices, optical storage devices, hard disks, flash memory, or any other suitable information storage device or combination of these devices. Thus, storage 26 stores, either permanently or temporarily, files 28 and other information, such as code 27 for processing by processor 22 and transmission by interface 24. Code 27 represents instructions, logic, programming, or programs appropriate to instruct processor 22 to control the operation of device 20. Files 28 represent any information stored and/or used by processor 22 in the operation of device 20. For example, files 28 may represent a database operable to store information associated with errors in memory module 30, such as location information, data stored at the location, the error type, date and/or time information, and/or other appropriate information.

Memory module 30 represents any suitable collection of hardware, software, and controlling logic operable to store information in memory banks 32 and monitor and repair memory banks 32 while online. Memory module 30 includes monitor module 34, test module 36, repair module 38, memory table 39, and alternate memory 40. For example, memory module 30 may represent a packet buffer operable to store serial input/output (I/O) received from interface 24. In some embodiments, the various illustrated components of memory 30 may be integrated into a single integrated circuit and/or embedded as an embedded dynamic RAM (eDRAM) subsystem.

Memory banks 32 and alternate memory 40 represent one or a combination of volatile or non-volatile local or remote devices suitable for storing information. For example, memory banks 32 and/or alternate memory 40 may include RAM, dynamic RAM (DRAM), eDRAM, static RAM (SRAM), ROM, or other appropriate component to store information. In various embodiments, memory module 30 may include any number or combination of memory banks 32 and/or alternate memory 40 according to the operational requirements of device 20. For example, memory module 30 may include thirty-two primary memory banks 32, one or more spare memory banks 32, and one or more alternate memories 40. Primary memory banks 32 are operable to store information and/or fulfill requests for access to data from processor 22 and/or interface 24 during the operation of device 20. Spare memory bank 32 is operable to store information and/or fulfill requests for access to data from processor 22 and/or interface 24 during the operation of device 20 when one or more of primary memory banks 32 is being tested. Any one of memory banks 32 may be designated as a primary memory bank or as a spare bank by monitor module 34 in order to monitor and repair memory banks 32 while online. Alternate memories 40 are operable to store information and/or fulfill requests for access to data to failed memory locations within memory banks 32 from processor 22 and/or interface 24 during the operation of device 20. As another example, memory banks 32 may represent eDRAM modules and/or alternate memories 40 may represent SRAM. Alternatively or in addition, memory banks 32 and/or alternate memories 40 may represent components of an integrated circuit and/or may be embedded as components of an eDRAM subsystem.

Each memory bank 32 may include any number, size, or combination of memory cells 33. The number and size of memory cells 33 may be predetermined by any number of factors associated with the operation of device 20, including capacity, expense, and/or other appropriate factors. Memory cells 33 may represent any combination of words, word addressable files, bytes, hard partitions, logical partitions, or any other appropriate subdivision of memory banks 32.

Monitor module 34 represents software, executable files, and/or appropriate logic modules capable, when executed, to monitor memory banks 32. Monitor module 34 monitors memory banks 32 by controlling the designation of primary and spare memory banks. Monitor module 34 may select a primary memory bank 32 to analyze for errors and designate a spare memory bank 32. Monitor module 34 may be operable to initiate a process of copying the information stored in primary memory bank 32 to spare memory bank 32. In some embodiments, monitor module 34 may be operable to continue to fulfill requests to access data in primary memory bank 32 during the copy process. Additionally or alternatively, monitor module 34 may include a mapping table to keep track of which memory banks 32 are being used as primary memory banks 32 and which are being used as spare memory banks 32. After copying, monitor module 34 may invoke test module 36 to analyze primary memory bank 32 for errors and/or to designate spare memory bank 32 to operate as primary memory bank 32. After testing, monitor module 34 may be operable to select another of primary memory banks 32 to analyze for errors and/or designate the tested primary memory bank 32 as spare memory bank 32. In some embodiments, monitor module 34 may represent a processor and/or a component of a processor. Alternatively or in addition, monitor module 34 may represent a component of an integrated circuit and/or may be embedded as a component of an eDRAM subsystem.

Test module 36 represents software, executable files, and/or appropriate logic modules capable, when executed, to test memory banks 32 by analyzing memory cells 33 for errors. For example, test module 36 may represent one or multiple built-in-self-test (BIST) engines. Test module 36 may perform any number of tests to analyze the memory bank 32 selected by monitor module 34 to test. For example, test module 36 may perform retention testing and/or at-speed testing using any test algorithm. Test module 36 may represent a programmable test algorithm. Test module 36 may run test programs received from files 28 via processor 22. In some embodiments, test module 36 may implement one or more of the following memory tests: address scrambling/descrambling, 3D addressing ability (row, column, bank), walking bit patterns, checkerboard patterns, butterfly patterns, galloping patterns (GALPAT), modified algorithmic test sequences (MATS), March-C algorithms, inner-loop addressing, bank-interleaving, pseudo-random address sequencing, pseudo-random data sequencing, 1-bit and 2-bit error correction via error correcting codes (ECC), or signal-integrity targeted testing for external memory, such as storage 26. Additionally or in the alternative, test module 36 may be interchangeable with any number of memory-type-specific interface modules. Test module 36 may thus be able to detect any number of types of errors within memory cells 33, including word I/O errors, weak bit lines, premature charge losses, retention errors, stuck-at-bit errors, crosstalk, adjacency errors, soft bit errors, or any number of appropriate errors. Test module 36 may invoke repair module 38 as a result of detecting errors within the tested memory bank 32. Test module 36 may transmit error information associated with detected memory cell errors to repair module 38. Error information may include location information, data stored at the location, the error type, date and/or time information, and/or other appropriate information. In some embodiments, test module 36 may represent a processor and/or a component of a processor. Alternatively or in addition, test module 36 may represent a component of an integrated circuit and/or may be embedded as a component of an eDRAM subsystem.

Repair module 38 represents software, executable files, and/or appropriate logic modules capable, when executed, to repair memory banks 32 while online. Repair module 38 may comprise necessary software, executable files, and/or logic modules to modify memory table 39 such that incoming requests to failed memory in memory bank 34 are redirected to alternate memory 40. Additionally or alternatively, repair module 38 may repair failed memory locations by activating redundant circuit elements and/or programmable fuses within memory banks 32. In some embodiments, repair module 38 may represent a processor and/or a component of a processor. Alternatively or in addition, repair module 38 may represent a component of an integrated circuit and/or may be embedded as a component of an eDRAM subsystem.

In the illustrated embodiment, repair module 38 includes memory table 39. Memory table 39 represents a table that stores information corresponding to failed memory locations in memory banks 32. For example, address table 39 may represent a content addressable memory (CAM) table. Each table entry of memory table 39 may correspond to locations within alternate memories 40.

In an exemplary embodiment of operation, processor 22 executes code 27 to control the operation and administration of elements within device 20. While controlling the operation and administration of elements within device 20, processor 22 may request access to memory banks 32. For example, processor 22 may request to read data from memory banks 32 and/or write data to memory banks 32. Processor 22 may additionally or alternatively receive error information from memory module 30. Errors received by processor 22 may include transient errors. For example, processor 22 may receive ECC information generated by memory module 30. ECC information may represent soft bit errors within memory banks 32. Processor 22 may store received error information in files 28. Processor 22 may analyze stored error information to identify memory online cells experiencing online degradation. In other words, processor 22 may analyze historical data stored in files 28 to identify recurring transient errors within the memory banks 32. If recurring transient errors are detected, processor 22 may direct repair module 38 to perform its repair functions for the memory cell 33 associated with the recurring transient error.

For purposes of illustration, memory module 30 comprises thirty-three memory banks 32 numbered consecutively from Bank₁ to Bank₃₃. However, it should be understood that any number of memory banks 32 are within the scope of the present disclosure.

Monitor module 34 continuously monitors memory banks 32 and selects one of memory banks 32 to further analyze. In some embodiments, monitor module 34 handles requests for access to memory banks 32 received from interface 24 or processor 24. Monitor module 34 may select any of memory banks 32, such as Bank₁, to analyze. Monitor module 34 may designate another of memory bank 32 to operate as a spare memory bank, such as Bank₃₃. In some embodiments, monitor module 34 may update its mapping table to keep track of memory banks 32 that are primary memory banks and memory banks 32 that are the spare memory bank. Spare memory bank 32 may be designated before monitor module 34 begins the analysis and/or after monitor module 34 determines which of memory banks 32 to further analyze. Monitor module 34 initiates a process of copying the contents of Bank₁ to Bank₃₃, wherein memory cells 33 from Bank₁ are copied to spare memory Bank₃₃. The contents of Bank₁ may be copied one or more memory cells 33 at a time.

If monitor module 34 receives a request for access to data to memory cell 33 within Bank₁ while copying memory cells 33 to spare memory Bank₃₃, monitor module 34 may continue copying while fulfilling the request. If monitor module 34 determines that the request for access includes a request to store and/or write information to Bank₁, monitor module 34 may redirect the request to a corresponding memory cell 33 within the spare memory bank 32. Accordingly, if a portion of memory cell 33 is being copied and a request to write new data to the same portion of memory cell 33 is received, the new data will be written to spare memory bank 32 while the copying process continues. For example, monitor module 34 may redirect requests using its mapping table. If monitor module 34 determines that the request for access includes a request to read information from Bank₁, monitor module 34 may direct the request to Bank₁ or Bank₃₃, depending on which bank comprises the most current data. Thus, monitor module 34 may give priority to requests to access data over the copying process, which ensures that spare memory bank 32 maintains a current copy of data within memory bank 32 selected for testing and/or ensures that requests to access data are not disrupted by the monitoring process. Accordingly, the copying process is transparent to any ongoing requests to access memory module 30. While fulfilling the request to access data, monitor module 34 may simultaneously continue the copying process.

Once the copying process is complete, monitor module 34 may designate spare memory bank 32 to operate as a primary memory bank 32. In this example, Bank₃₃ is designated to operate as Bank₁, and memory module 34 may then invoke test module 36 to analyze Bank₁ for errors. Thus, while Bank₁ is undergoing testing, Bank₃₃ fulfills the requests to access data that were originally directed to Bank₁.

Test module 36 performs one or more tests on memory bank 32 designated by monitor module 34 for testing. In this example, test module 36 analyzes Bank₁ for one or more memory errors. Memory errors include failures in one or more memory cells 33. Test module 36 may perform any of the previously described memory tests to detect memory errors in Bank₁. If test module 36 does not detect any memory errors in Bank₁, test module 36 may return operation to monitor module 34. If test module 36 detects one or more errors in Bank₁, test module 36 may invoke repair module 38 to attempt to repair the error and/or transmit error information to processor 22 for storage in files 28.

Repair module 38 may receive error information from test module 36 and repair detected errors within memory banks 32. Based on the error information, repair module 38 may determine if the error is repairable. If determined to be repairable, repair module 38 may attempt to repair the error. For example, repair module 38 may store the location information associated with the detected memory cell error as a table entry in an address table 39. Repair module 38 may read the data stored at the location associated with the error in memory cell 33, attempt to correct any failed and/or corrupted data, and store the corrected data at an alternate memory location in alternate memories 40. Accordingly, new requests to access data at the location associated with the error will be redirected to the data stored in alternate memory 40.

When a request to access a memory location in memory banks 32 is received by monitor module 34, monitor module 34 may analyze address table 39 to determine if the requested memory location is stored therein. If address table 39 includes the requested location, monitor module 34 may fulfill the request by providing access to the associated alternate location in alternate memories 40. If address table 39 does not include the requested location, monitor module 34 may fulfill the request by providing access to the requested location in memory banks 32. After repairing and/or attempting to repair the error, repair module 38 may return operation to monitor module 34.

After testing and/or repairing, monitor module 34 may designate Bank₁ as the new spare memory bank 32, and select another memory bank 32 from Bank₁ to Bank₃₃ to test, such as Bank₂. This process may be repeated such that every bank of memory banks 32 is tested. Monitor module 34 may test each memory bank 32 in any order, including randomly, sequentially, and/or in response to a request to test a particular memory bank 32 received from processor 22. Once every memory bank 32 is tested, monitor module 34 may repeat the entire process. Thus, memory banks 32 may be continuously and non-disruptively monitored while remaining online.

Various modifications may be made to device 20 for monitoring and repairing memory online described in the present disclosure. For example, while shown as residing in memory module 30, monitor module 34, test module 36, repair module 38 may be included in processor 22 or may be stored in storage 26 as code 27. In some embodiments, monitor module 34 may process most requests to access data in parallel with the copying process, and may suspend the copying process if a request is associated with memory cell 33 currently being copied. In various embodiments, monitor module 34 may suspend the copying process if the request is a request to write data associated with the memory cell 33 currently being copied and/or may not suspend the copying process if the request is a request to read data associated with memory cell 33 currently being copied. Another modification may include the ability for monitor module 34 to increase the capacity of memory module 30 when needed and/or when requested by ceasing to monitor and repair memory and designating the spare memory bank 32 as an additional primary memory bank 32.

Additionally, while the illustrated embodiment shows a test module 36, the functions of test module 36 may be carried out by processor 22 by executing test instructions residing in code 27. As another example, errors detected by test module 36 and/or processor 22 may be logged in files 28 and/or other appropriate hardware. When a predetermined number of errors within a memory bank 32 is reached, processor 22 and/or test module 36 may instruct monitor module 34 to take memory bank 32 out of service. In other words, once memory bank 32 reaches a certain point of degradation, system 10 may designate memory bank 32 as unusable and/or out-of-service. In this example, monitor module 34 may designate the out-of-service bank 32 to operate, either permanently, semi-permanently, or temporarily, as spare memory bank 32. Monitor module 34 may then cease performing its monitoring functions. Additionally or alternatively, processor 22 may invoke a process stored in code 27 to notify an appropriate entity that memory module 30 needs replacement and/or service.

Logic encoded in media may comprise software, hardware, instructions, code, logic, and/or programming encoded and/or embedded in one or more non-transitory and/or tangible computer-readable media, such as volatile and non-volatile memory modules, integrated circuits, hard disks, optical drives, flash drives, CD-Rs, CD-RWs, DVDs, ASICs, and/or programmable logic controllers.

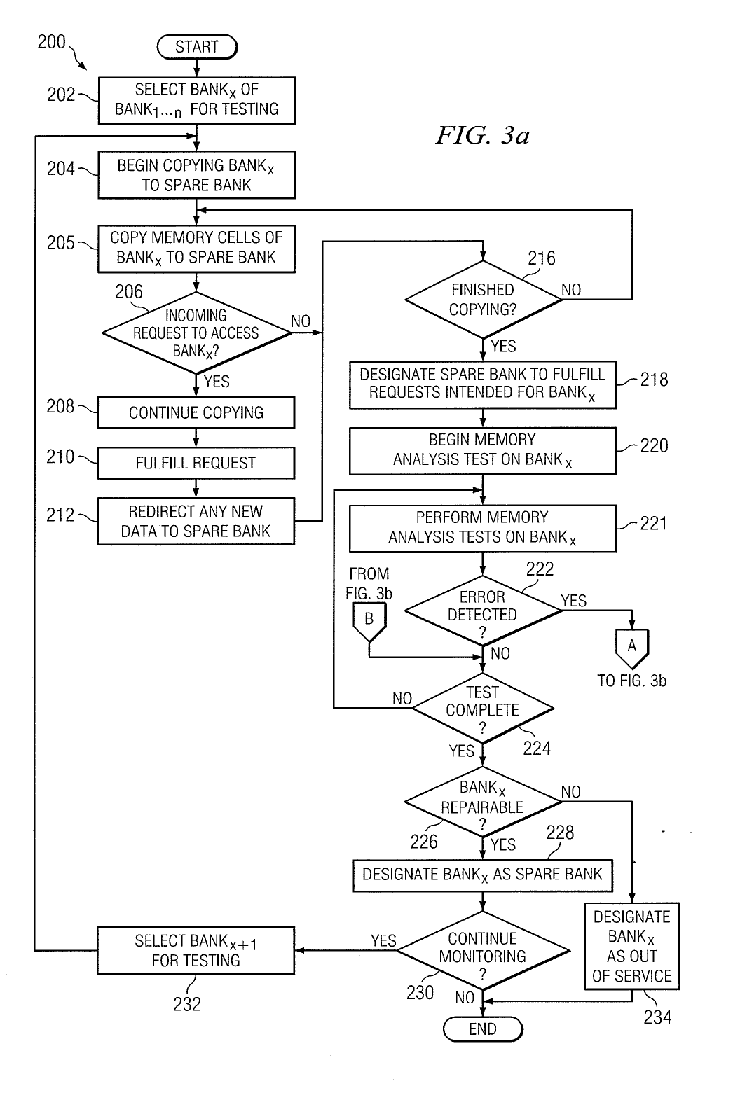

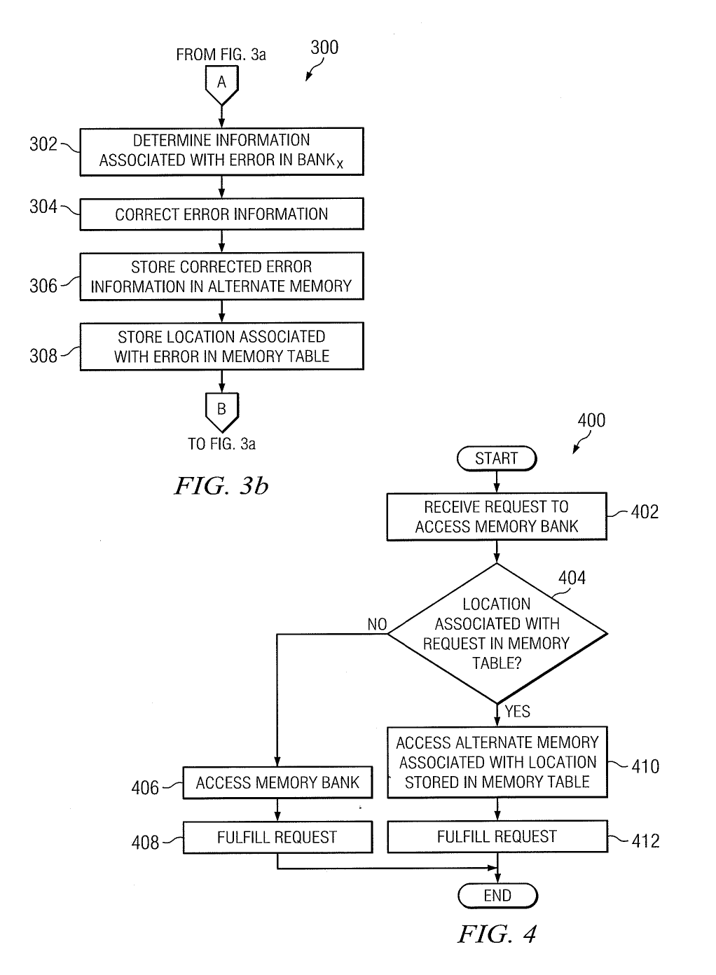

FIG. 3A is a flowchart illustrating an example method 200 for monitoring and repairing memory online. In the illustrated method, memory banks 32 comprise any number n of memory banks 32 labeled sequentially from Bank₁ to Bankₙ. One memory bank 32 is designated as a spare memory bank 32 and the remaining memory banks 32 are designated as primary memory banks 32.

At step 202, Bankₓ of primary memory banks 32 is selected for testing. After being selected for testing at step 202, a process of copying Bankₓ to spare memory bank 32 is initiated at step 204. The copying process initiated at step 204 includes copying the memory cells 33 of Bankₓ to spare memory bank 32 at step 205. During the copying process, if an incoming request to access Bankₓ is received at step 206, memory module 30 continues copying at step 208 and fulfills the request at step 210. As previously discussed, requests to access Bankₓ may include read and/or write requests. At step 210, memory module 30 may direct read requests to Bankₓ or spare memory bank 32 depending on which bank has the most current data. If the request to access Bankₓ is a request to write data to Bankₓ, any new data may be written to the appropriate location in spare memory bank 32 at step 212. Thus, the process ensures that spare memory bank 32 will comprise the most current copy of data designated for storage in Bankₓ once the copying process is complete. Alternatively or in addition, the copying process ensures that requests for access to memory banks 32 are not disrupted and/or requests for access to memory banks 32 are fulfilled correctly.

While dealing with incoming requests for access to data at steps 208 to 212, or if no incoming requests were received at step 206, a determination is made whether copying of Bankₓ to spare memory bank 32 has finished at step 216. If copying has not finished, copying continues at step 205.

Once copying Bankₓ to spare memory bank 32 is completed at step 216, the spare memory bank 32 is designated at step 218 to fulfill incoming requests to access information in Bankₓ. Thus, requests to read information from and/or write information to Bankₓ will be redirected to spare memory bank 32. At step 220, a memory analysis test on Bankₓ is initiated. Step 220 may include selecting any number and/or types of memory analysis tests to perform, including those previously described as capable of being performed by test module 36. At step 221, the selected memory analysis tests are performed to detect any errors associated with memory cells 33 in Bankₓ. If an error is detected at step 222, a process may be invoked to repair the error, an example of which will be described in greater detail with respect to FIG. 3B below. If an error is not detected at step 222 and/or after the repair procedure is completed, a determination is made whether the selected memory analysis test is complete at step 224. If the selected test is not complete, method 200 returns to step 221 so that the memory analysis test may continue.

If the test is complete, a determination is made at step 226 whether Bankₓ is repairable. This determination may be made based on the failure of the repair procedure to repair the errors detected by the memory analysis tests and/or may be based on reaching a predetermined number of memory cell errors within Bankₓ. For example, the predetermined number of memory cell errors may represent a level of degradation of Bankₓ that indicates Bankₓ is failing, has failed, or is likely to fail.

If Bankₓ is determined not to be repairable at step 226, method 200 may proceed to step 234 and Bankₓ may be designated as out of service. Step 234 may include taking Bankₓ offline and designating spare memory bank 32 to permanently, semi-permanently, or temporarily fulfill requests for access to Bankₓ until Bankₓ and/or memory module 30 can be serviced or replaced. After Bankₓ is taken offline at step 234, the monitoring process may end and/or device 20 may notify an appropriate entity that Bankₓ and/or memory module 30 is in need of replacement or service.

If Bankₓ is determined to be repairable at step 226, Bankₓ may be designated as spare memory bank 32 at step 228. A determination is made at step 230 whether to continue monitoring memory banks 32. If the determination is made to continue at step 230, another primary memory bank 32 is selected for testing at step 232. For example, the next primary memory bank 32, such as Bankₓ₊₁ may be selected. As another example, a request may be received from processor 22 to test one of memory banks 32. After another bank, such as Bankₓ₊₁, is selected at step 232, method 200 returns to step 204 and the process of copying Bankₓ₊₁ to new spare bank Bankₓ is initiated. Otherwise, the method ends.

Modifications, additions, or omissions may be made to method 200 illustrated in the flowchart of FIG. 3A. For example, method 200 may include designating more than one of memory banks 32 as a spare memory bank 32. As another example, method 200 may invoke a repair procedure for any detected errors after the memory analysis tests are concluded at step 224. Accordingly, the steps of FIG. 3A may be performed in parallel or in any suitable order.

FIG. 3B is a flowchart illustrating an example method 300 for repairing memory. Method 300 may be invoked at any time an error associated with memory banks 32 is detected, such as an error in memory cell 33. In the illustrated embodiment, method 300 may be invoked in conjunction with method 200 to repair memory cell errors in Bankₓ detected at step 222.

At step 302, error information associated with the detected error in Bankₓ is determined. As previously described, error information may include location information, data stored at the location, the error type, date and/or time information, and/or other appropriate information. Additionally or alternatively, error information may include faulty data stored at the failed location associated with memory cell 33 in Bankₓ. At step 304, error information may be corrected. For example, the faulty data stored at the failed location associated with memory cell 33 may be corrected.

At step 306, corrected error information may be stored in alternate memories 40. For example, the faulty data that was stored at the failed location in memory cell 33 and corrected at step 304 may be stored at a location in alternate memories 40 at step 306.

At step 308, the location information associated with the error in memory cells 33 may be stored as an entry in memory table 39. The entry in memory table 39 corresponds to the location in alternate memories 40 where the corrected information is stored. Thus, method 300 repairs the detected errors in memory banks 32 by providing an alternate location in alternate memories 40 for the failed location in memory cells 33. The method continues to step 224 in FIG. 3A.

Modifications, additions, or omissions may be made to method 300 illustrated in the flowchart of FIG. 3B. For example, method 300 may include determining the availability of redundant circuit elements in memory banks 32, and activating the redundant circuit elements if available. Additionally, the steps of FIG. 3B may be performed in parallel or in any suitable order.

FIG. 4 is a flowchart illustrating an example method 400 for accessing a repairable memory. For example, FIG. 4 may illustrate a method 400 of accessing memory repaired using method 300 as illustrated in FIG. 3B.

At step 402, a request is received to access memory bank 32. A determination is made at step 404 whether the location associated with the request is stored as an entry in memory table 39. If the location associated with the request is not stored in memory table 39 at step 404, method 400 continues to step 406. At step 406, the appropriate memory bank 32 is accessed to fulfill the request. If the memory bank 32 associated with the request for access is currently selected for testing by monitor module 34, the primary or spare memory bank 32 may be accessed in accordance with the previously described monitor and repair process as shown in FIG. 3A. At step 408, the request to access memory bank 32 is fulfilled by accessing the appropriate memory bank 32 and the process subsequently ends.

If the location associated with the request is stored in address table 39 at step 404, method 400 proceeds to step 410. At step 410, access is provided to the location in alternate memory 40 associated with the entry in memory table 39. For example, alternate memory 40 may comprise the corrected information from the failed location associated with the memory cell 33. At step 412, the request for access to memory bank 32 is fulfilled by accessing the alternate memory 40 and the process subsequently ends.

Modifications, additions, or omissions may be made to method 400 illustrated in the flowchart of FIG. 4. For example, method 400 may process several requests for access to data at once and/or in parallel. Additionally, the steps of FIG. 4 may be performed in parallel or in any suitable order.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A method for monitoring and repairing memory, comprising:
selecting a first memory bank comprising a plurality of memory cells to analyze;
copying the plurality of memory cells from the first memory bank to a second memory bank, wherein a request to access the first memory bank is redirected to the second memory bank; and
determining whether the first memory bank comprises an error of the memory cell.

2. The method of claim 1, further comprising:
receiving a request to access the first memory bank;
continuing the copying of the plurality of memory cells;
accessing the second memory bank to fulfill the request.

3. The method of claim 1, further comprising:
designating the second memory bank as a primary memory bank; and
designating the first memory bank as a spare memory bank.

4. The method of claim 1, further comprising:
identifying an error associated with a memory cell;
determining that the identified memory cell error is a transient error;
storing a location associated with the transient error in a database; and
analyzing the stored transient error location to identify a recurring error.

5. The method of claim 4, wherein the transient error is associated with one or more Error Correcting Codes (ECCs).

6. The method of claim 1, further comprising:
identifying an error associated with a memory cell;
determining that the memory cell error is repairable; and
repairing the memory cell error by activating one or more redundant circuit elements associated with the first memory bank.

7. The method of claim 1, further comprising:
identifying an error associated with a memory cell;
storing a location associated with the identified memory cell error in a memory table to repair the identified memory cell error; and
redirecting a request to access the identified location to an alternate memory location associated with the memory table.

8. The method of claim 1, further comprising:
determining that the first memory bank comprises a plurality of memory cell errors;
determining if the plurality of memory cell errors has reached a predetermined limit; and
designating the first memory bank as out-of-service if the pre-determined limit has been reached.

9. A non-transitory computer readable medium comprising logic, the logic, when executed by a processor, operable to:
select a first memory bank comprising a plurality of memory cells to analyze;
copy the plurality of memory cells from the first memory bank to a second memory bank, wherein a request to access the first memory bank is redirected to the second memory bank; and
determine whether the first memory bank comprises an error of the memory cell.

10. The medium of claim 9, further operable to:
receive a request to access the first memory bank;
continue the copying of the plurality of memory cells; and
access the second memory bank to fulfill the request.

11. The medium of claim 9, further operable to:
designate the second memory bank as a primary memory bank; and
designate the first memory bank as a spare memory bank.

12. The medium of claim 9, further operable to:
identify an error associated with a memory cell;
determine that the identified memory cell error is a transient error;
store a location associated with the transient error in a database; and
analyze the stored transient error location to identify a recurring error.

13. The medium of claim 12, further operable to, wherein the transient error is associated with one or more Error Correcting Codes (ECCs).

14. The medium of claim 9, further operable to:
identify an error associated with a memory cell;
determine that the memory cell error is repairable; and
repair the memory cell error by activating one or more redundant circuit elements associated with the first memory bank.

15. The medium of claim 9, further operable to:
identify an error associated with a memory cell;
store a location associated with the identified memory cell error in a memory table to repair the identified memory cell error; and
redirect a request to access the identified location to an alternate memory location associated with the memory table.

16. The medium of claim 9, further operable to:
determine that the first memory bank comprises a plurality of memory cell errors;
determine if the plurality of memory cell errors has reached a predetermined limit; and
designate the first memory bank as out-of-service if the pre-determined limit has been reached.

17. An apparatus for monitoring and repairing memory, comprising:
a first memory bank comprising a plurality of memory cells;
a monitor module comprising a processor component and operable to:
select the first memory bank to analyze;
copy the plurality of memory cells from the first memory bank to a second memory bank, wherein a request to access the first memory bank is redirected to the second memory bank; and
a test module comprising a second processor component and operable to:
determine whether the first memory bank comprises an error of the memory cell.

18. The apparatus of claim 17, wherein the monitor module is further operable to:
receive a request to access the first memory bank;
continue the copying of the plurality of memory cells; and
access the second memory bank to fulfill the request.

19. The apparatus of claim 17, wherein the monitor module is further operable to:
designate the second memory bank as a primary memory bank; and
designate the first memory bank as a spare memory bank.

20. The apparatus of claim 17, further comprising a repair module comprising a third processor component and further operable to:
identify an error associated with a memory cell;
determine that the identified memory cell error is a transient error;
store a location associated with the transient error in a database; and
analyze the stored transient error location to identify a recurring error.
